(19) United States
(12) Patent Application Publication
(10) Pub. No.: US 2016/0260426 A1
(43) Pub. Date: Sep. 8, 2016

(54) SPEECH RECOGNITION APPARATUS AND METHOD

(71) Applicant: Electronics and Telecommunications Research Institute, Daejeon (KR)

(72) Inventors: Young Ik KIM, Daejeon (KR); Sang Hun KIM, Daejeon (KR); Min Kyu LEE, Daejeon (KR); Mu Yeol CHOI, Daejeon (KR)

(21) Appl. No.: 15/058,550

(22) Filed: Mar. 2, 2016

(30) Foreign Application Priority Data
Mar. 2, 2015 (KR) 10-2015-0028913

(51) Int. Cl. G10L 15/05; G10L 15/14; G10L 25/87; G10L 25/30

(52) U.S. Cl. CPC G10L 15/05; G10L 25/30; G10L 15/14; G10L 25/87

(57) ABSTRACT

A speech recognition apparatus and method are provided, the method including converting an input signal to acoustic model data, dividing the acoustic model data into a speech model group and a non-speech model group and calculating a first maximum likelihood corresponding to the speech model group and a second maximum likelihood corresponding to the non-speech model group, detecting a speech based on a likelihood ratio (LR) between the first maximum likelihood and the second maximum likelihood, obtaining utterance stop information based on output data of a decoder and dividing the input signal into a plurality of speech intervals based on the utterance stop information, calculating a confidence score of each of the plurality of speech intervals based on information on a prior probability distribution of the acoustic model data, and removing a speech interval having the confidence score lower than a threshold.

### CROSS-REFERENCE TO RELATED APPLICATION

This application claims the priority benefit of Korean Patent Application No. 10-2015-0028913, filed on Mar. 2, 2015, in the Korean Intellectual Property Office, the disclosure of which is incorporated herein by reference.

### BACKGROUND

1. Field of the Invention

Embodiments relate to a speech recognition apparatus and method, and more particularly, to a speech recognition apparatus and method for performing speech detecting and speech segment selecting.

2. Description of the Related Art

Recently, a usage scope of a speech recognizer has been extended due to an improvement in performance of mobile devices. In related technology, a method of dividing a speech segment, a noise segment, and a background noise is referred to as an end point detection (EPD) or a voice activity detection (VAD). A processing speed of an automatic speed recognizer is determined based on a function of speech segment detecting, and recognition performance is determined in an environment with noise. Accordingly, research on the related art is in progress.

A method of using edge information on a speech signal may have a feature in which the edge information is inaccurate when the speech signal has a similar shape of a tone signal, and a feature in which a speech segment is not accurately detected based on the edge information when a noise level is greater than or equal to a threshold.

In addition, a method of modeling, in a frequency area, the speech signal based on a probability distribution and determining a speech segment by analyzing a statistical feature of a probability model in various noise environments may be provided. However, in such a statistical approach, providing an appropriate type of noise models through a learning process in advance may be required.

### SUMMARY

According to an aspect, there is provided a speech recognition apparatus including a converter configured to convert an input signal to acoustic model data, a calculator configured to divide the acoustic model data into a speech model group and a non-speech model group and calculate a first maximum likelihood corresponding to the speech model group and a second maximum likelihood corresponding to the non-speech model group, and a detector configured to detect a speech based on a likelihood ratio (LR) between the first maximum likelihood and the second maximum likelihood. The converter may be configured to convert the input signal to the acoustic model data based on a statistical model, and the statistical model may include at least one of a Gaussian mixture model (GMM) and a deep neural network (DNN). The calculator may be configured to calculate an average LR between the first maximum likelihood and the second maximum likelihood based on the acoustic model data corresponding to a predetermined time interval, and the detector is configured to detect a speech based on the average LR.

The calculator may be configured to calculate a third maximum likelihood corresponding to an entirety of the acoustic model data, and the detector is configured to detect a speech based on an LR between the second maximum likelihood and the third maximum likelihood. The calculator may be configured to calculate an average LR between the second maximum likelihood and the third maximum likelihood based on the acoustic model data corresponding to a predetermined time interval, and the detector is configured to detect the speech based on the average LR. The detector may be configured to detect a starting point at which the speech is detected from the input signal and set the input signal input subsequent to the starting point, as a decoding search target.

According to another aspect, there is provided a speech recognition apparatus including a determiner configured to obtain utterance stop information based on output data of a decoder and divide an input signal into a number of speech segments based on the utterance stop information, a calculator configured to calculate a confidence score of each of the speech segments based on information on a prior probability distribution of acoustic model data, and a detector configured to remove, among the speech segments, a speech segment having the confidence score lower than a threshold and perform speech recognition. The utterance stop information may include at least one of utterance pause information and sentence end information.

The calculator may be configured to calculate and store the prior probability distribution for each class of each of a target speech and a noise speech according to a sound modeling scheme corresponding to the acoustic model data. The calculator may be configured to approximate the prior probability distribution for each class as a predetermined function, and calculate the confidence score using the predetermined function. The calculator may be configured to store the information on the prior probability distribution for each class, and calculate the confidence score based on the information on the prior probability distribution. The calculator may be configured to store at least one of a mean value or a variance value of the prior probability distribution as the information on the prior probability distribution. The calculator may be configured to calculate the confidence score and a distance from the prior probability distribution by comparing the information on the prior probability distribution to the acoustic model data of the speech segments.

According to still another aspect, there is provided a speech recognition method including converting an input signal to acoustic model data, dividing the acoustic model data into a speech model group and a non-speech model group and calculating a first maximum likelihood corresponding to the speech model group and a second maximum likelihood corresponding to the non-speech model group, detecting a speech based on an LR between the first maximum likelihood and the second maximum likelihood, obtaining utterance stop information based on output data of a decoder when the detecting of the speech begins and dividing the input signal into a number of speech segments based on the utterance stop information, calculating a confidence score of each of the speech segments based on information on a prior probability distribution of the acoustic model data, and removing, among the speech segments, a speech segment having the confidence score lower than a threshold. The converting may include converting the input signal to the acoustic model data based on at least one of a GMM and a DNN.

The detecting of the speech may include calculating an average LR between the first maximum likelihood and the second maximum likelihood based on the acoustic model data corresponding to a predetermined time interval. The detecting of the speech may include setting a threshold based on the acoustic model data and detecting the speech when the average LR is greater than the threshold.

The speech recognition method may further include calculating and storing the prior probability distribution for each class of each of a target speech and a noise speech according to a sound modeling scheme corresponding to the acoustic model data. The calculating of the confidence score may include approximating the prior probability distribution for each class as a predetermined function, and calculating the confidence score using the predetermined function. The calculating of the confidence score may include calculating a distance from the prior probability distribution of the acoustic model data based on the information on the prior probability distribution, and the information on the prior probability distribution may include at least one of a mean value and a variance value of the prior probability distribution.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a block diagram illustrating an example of a speech recognition apparatus according to an embodiment;

FIGS. 2A through 2C are likelihood ratio (LR) calculating graphs according to an embodiment;

FIG. 3 is a block diagram illustrating another example of a speech recognition apparatus according to an embodiment;

FIG. 4 is a graph illustrating performing speech segment selecting according to an embodiment; and

FIG. 5 is a flowchart illustrating an example of a speech recognition method according to an embodiment.

### DETAILED DESCRIPTION

Reference will now be made in detail to embodiments of the present invention, examples of which are illustrated in the accompanying drawings, wherein like reference numerals refer to the like elements throughout. Embodiments are described below to explain the present invention by referring to the figures.

Unless otherwise defined, all terms including technical and scientific terms used herein have the same meaning as commonly understood by one of ordinary skill in the art to which the present invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Terms used herein are defined to appropriately describe the example embodiments of the present invention and thus may be changed depending on a user, the intent of an operator, or a custom. Also, some specific terms used herein are selected by applicant(s) and such terms will be described in detail. Accordingly, the terms used herein must be defined based on the following overall description of this specification.

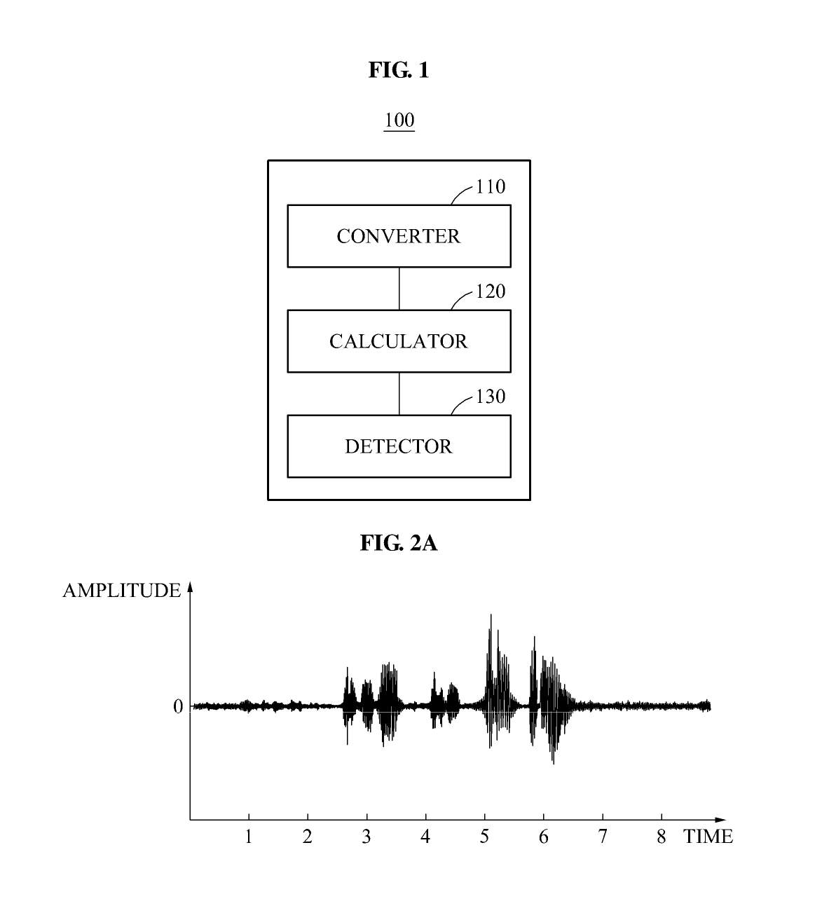

FIG. 1 is a block diagram illustrating an example of a speech recognition apparatus according to an embodiment.

A speech recognition apparatus 100 includes a converter 110, a calculator 120, and a detector 130. The speech recognition apparatus 100 converts an input signal to acoustic model data based on a sound modeling scheme, and detects a speech based on a likelihood ratio (LR) of the acoustic model data. The speech recognition apparatus 100 may perform bottom-up speech detecting.

The converter 110 converts an input signal to acoustic model data. The converter 110 obtains the input signal as the acoustic model data based on an acoustic model. For example, an acoustic model may include a Gaussian mixture model (GMM) or a deep neural network (DNN), but is not limited thereto. In an input signal process, the converter 110 may directly use the acoustic model used for the speech recognition. Speech detecting technology according to the present embodiment may minimize feature extracting calculations for speech detecting thereby performing the speech detecting having a high degree of accuracy.

The calculator 120 divides the acoustic model data into a speech model group and a non-speech model group. The speech model group may include a phoneme, and the non-speech model group may include silence. The calculator 120 may calculate a first maximum likelihood in the speech model group. The calculator 120 may calculate a second maximum likelihood in the non-speech model group. The calculator 120 may calculate an average LR between the first maximum likelihood and the second maximum likelihood based on the acoustic model data corresponding to a predetermined time interval. In an example, the speech recognition apparatus 100 may use an average LR between the first maximum likelihood and the second maximum likelihood, as a feature of a speech for speech detecting. Hereinafter, an operation of the detector 130 will be described in detail.

In another example, the calculator may calculate a likelihood with respect to an entirety of the acoustic model data. The calculator 120 may calculate a third maximum likelihood corresponding to the entirety of the acoustic model data. In addition, the calculator 120 may calculate an average LR between the third maximum likelihood and the second maximum likelihood calculated in the non-speech model group based on the acoustic model data corresponding to the predetermined time interval.

The detector 130 detects a speech based on a maximum LR of the speech. In an example, the detector 130 may detect a speech based on an LR between the first maximum likelihood and the second maximum likelihood. In detail, the detector 130 may detect a speech based on an average LR between the first maximum likelihood and the second maximum likelihood based on the acoustic model data corresponding to the predetermined time interval. The detector 130 may set a threshold, and detect the speech with respect to an input signal having the average LR greater than or equal to the threshold.

In another example, the detector 130 may detect the speech based on an LR between the second maximum likelihood and the third maximum likelihood corresponding to an entirety of the acoustic model data. In more detail, the detector 130 may detect the speech based on an average LR between the third maximum likelihood and the second maximum likelihood calculated based on the acoustic model data corresponding to the predetermined time interval. In addition, the detector 130 may set the threshold and detect the speech with respect to the input signal having the LR greater than or equal to the threshold. The detector 130 may detect a starting point at which the speech begins to be detected from the input signal. The detector 130 may set the input signal input subsequent to the starting point, as a decoding search target.

The descriptions of the speech recognition apparatus 100 are also applicable to a speech recognition method. The speech recognition method may include converting an input signal to acoustic model data, dividing the acoustic model data into a speech model group and a non-speech model group, calculating a first maximum likelihood corresponding to the speech model group and a second maximum likelihood corresponding to the non-speech model group, and detecting a speech based on an LR between the first maximum likelihood and the second maximum likelihood.

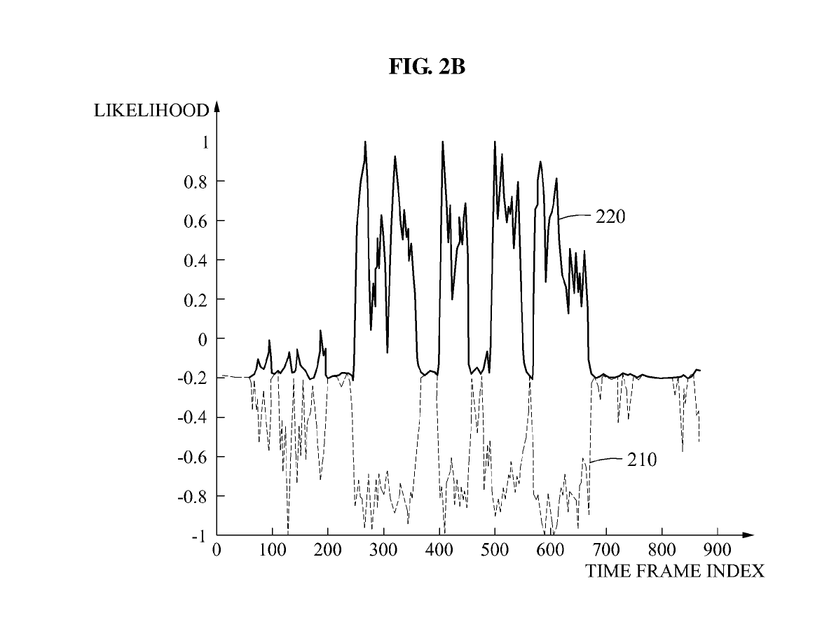

FIGS. 2A through 2C are LR calculating graphs according to an embodiment.

FIG. 2A is a graph illustrating an input signal according to an embodiment. An X-axis indicates a time, and a Y-axis indicates amplitude of an input signal. The input signal illustrated in FIG. 2A may include a target speech to be detected, a noise speech, and noise. The input signal may be converted to acoustic model data according to an acoustic model. The converter 110 may convert the input signal to acoustic model data. As illustrated in FIG. 2A, acoustic model data is obtained based on a DNN acoustic model.

FIG. 2B is a graph illustrating a likelihood of DNN acoustic model data. An X-axis indicates a time frame index corresponding to a predetermined time interval, and a Y-axis indicates a likelihood of a log scale. A curve 210 refers to a likelihood calculated based on an entirety of the acoustic model data, and a curve 220 refers to a likelihood calculated based on a non-speech model group. The calculator 120 may calculate a likelihood based on each of a speech model group and a non-speech model group. Referring to FIG. 2, the calculator 120 may obtain a second maximum likelihood in the non-speech model group and a third maximum likelihood in the acoustic model data. An LR of the second maximum likelihood and the third maximum likelihood may be a feature to determine an existence of speech. In addition, the calculator 120 may calculate an average LR of a maximum likelihood corresponding to a predetermined time interval. The average LR corresponding to the predetermined time interval may be a feature to determine an existence of speech.

FIG. 2C is an LR graph of a second maximum likelihood and the third maximum likelihood. An X-axis indicates a time frame index corresponding to a predetermined time, and a Y-axis indicates an LR. The calculator 120 may calculate an LR. In addition, the calculator 120 may calculate an average LR corresponding to the predetermined time interval. The detector 130 may detect a presence of a predetermined speech in an input signal based on the average LR. For example, the detector 130 may set a threshold for speech detecting. In detail, when the calculated average LR is greater than or equal to the threshold, the detector 130 may detect the presence of the predetermined speech in the input signal. Referring to FIG. 2C, an LR greater than or equal to “0.5” is set as a threshold, and a presence of a predetermined speech may be determined. For example, the detector 130 may set an LR corresponding to “0.5” as a threshold.

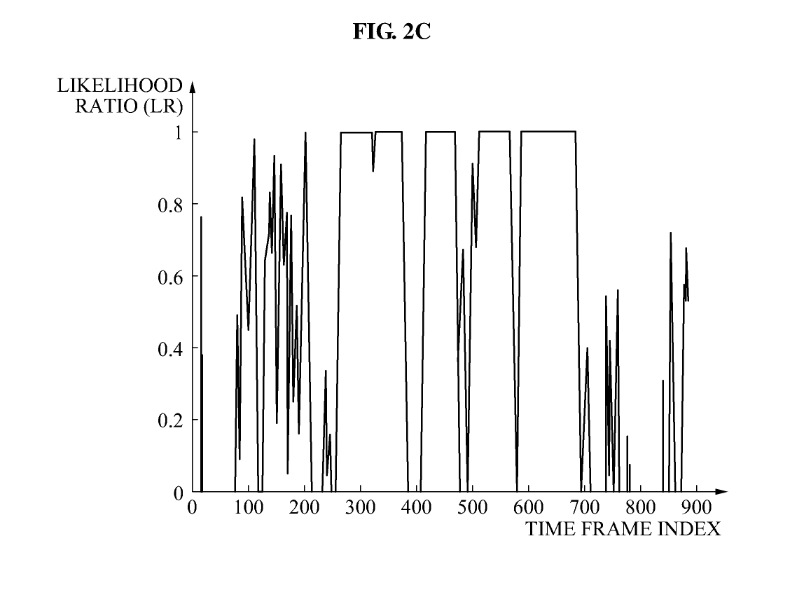

FIG. 3 is a block diagram illustrating another example of a speech recognition apparatus according to an embodiment.

A speech recognition apparatus 300 includes a determiner 310, a calculator 320, and a detector 330. The speech recognition apparatus 300 selects a time interval including a target speech to be recognized in an entirety of an input signal. The speech recognition apparatus 300 may remove, among the entirety of input signal including the target speech and a noise speech, a time interval including a noise speech having a relatively low confidence score. The speech recognition apparatus 300 may perform top-down speech segment selecting.

The determiner 310 may obtain utterance stop information based on output data of a decoder with respect to an input signal. The utterance stop information may include at least one of utterance pause information and sentence end information. The determiner 310 may obtain the utterance stop information from the output data of the decoder based on a best hypothesis of speech recognition. For example, the output data of the decoder may include a speech recognition token. The speech recognition token may include the utterance pause information and the sentence end information. For example, a highest rated hypothesis of speech recognition may be generated in acoustic model data to be searched by the decoder. The determiner 310 may divide an entirety of the input signal into a number of speech segments. The determiner 310 may divide an interval from a first time frame index in which a speech begins to a second frame index in which the utterance stop information is obtained into a speech segment. The determiner 310 may divide a speech segment with respect to the entirety of the input signal.

The calculator 320 may calculate a confidence score of each of the speech segments based on information on prior probability distribution of the acoustic model data. The calculator 320 may calculate and store the prior probability distribution for each class of each of a target speech and a noise speech according to a sound modeling scheme corresponding to the acoustic model data.

In an example, the calculator 320 may approximate the prior probability distribution for each class as a predetermined function, and calculate the confidence score using the predetermined function. For example, the calculator 320 may approximate a prior probability distribution in detail using a beta function. In addition, the calculator 320 may subsequently calculate a probability for each class with respect to a new input signal using an approximation function.

In another example, the calculator 320 may store the information on the prior probability distribution for each class. For example, information on a prior probability distribution may include at least one of a mean value or a variance value of the prior probability distribution. The calculator 320 may calculate the confidence score and a distance from the prior probability distribution by comparing the information on the prior probability distribution to the acoustic model of the speech segments.

The detector 330 may remove, among the speech segments, a speech segment having the confidence score lower than a threshold. The detector 330 may set the threshold according to the acoustic model data. The detector 330 may remove the speech segment having a relatively low confidence score from an entirety of the input signal. The speech recognition apparatus 300 may remove a speech segment having a relatively low confidence score since a noise speech is included, thereby enhancing performance of a speech recognition system.

Also, the descriptions of the speech recognition apparatus 300 may be applied to a speech recognition method. According to an embodiment, a speech segment selecting method may include obtaining utterance stop information based on output data of a decoder with respect to an input signal when the detecting of the speech begins, dividing the input signal into a number of speech segments based on the utterance stop information, calculating a confidence score of each of the speech segments based on information on a prior probability distribution of the acoustic model data, and removing, among the speech segments, a speech segment having the confidence score lower than a threshold.

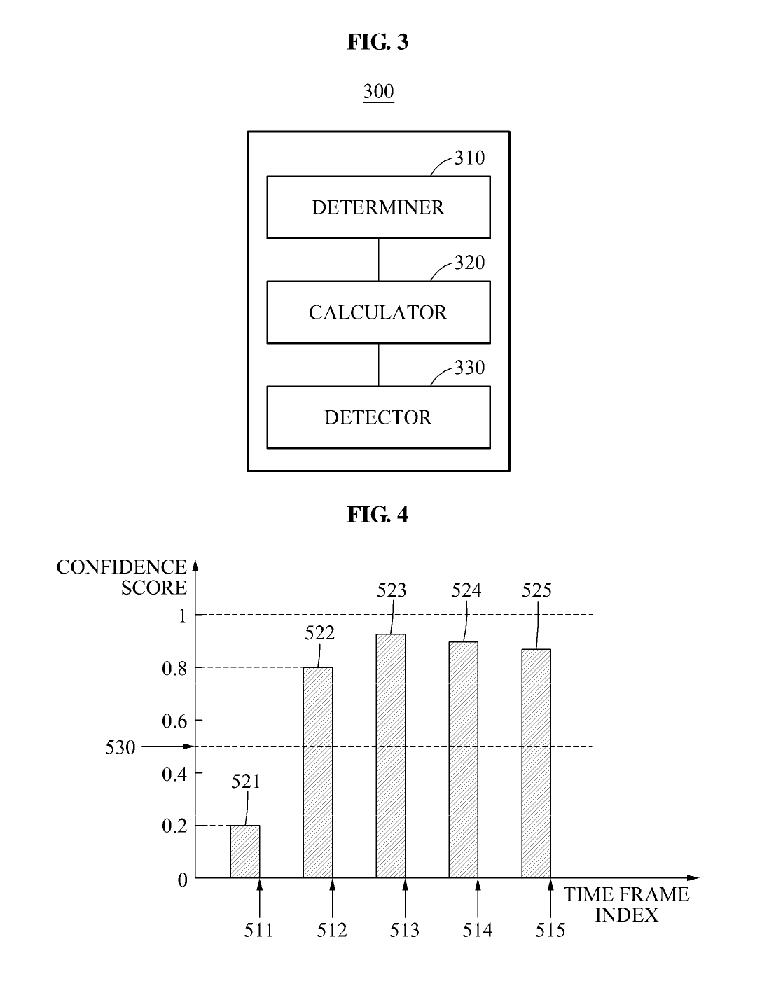

FIG. 4 is a graph illustrating performing speech segment selecting according to an embodiment.

Referring to FIG. 4, an X-axis indicates a time frame index, and a Y-axis indicates a confidence score. The determiner 310 obtains utterance stop information 411, 412, 413, 414, and 415. As illustrated in FIG. 4, the utterance stop information 411 and 415 are sentence end information, and the utterance stop information 412, 413, and 414 are utterance pause information. The determiner 310 may divide an entirety of input signal into a number of speech segments 421, 422, 423, 424, and 425 based on the utterance stop information 411, 412, 413, 414, and 415. The detector 330 may set a threshold 430 in order to remove a speech segment having a relatively low confidence score. In an example, according to a feature of an acoustic model data, the detector 330 may determine a threshold. For example, referring to FIG. 4, the detector 330 may set the threshold 430 to be “0.5”. The detector 330 may remove the speech segment 421 having the confidence score lower than the threshold 430. Accordingly, the speech recognition apparatus 300 may perform speech recognition during the speech segments 422, 423, 424, and 425.

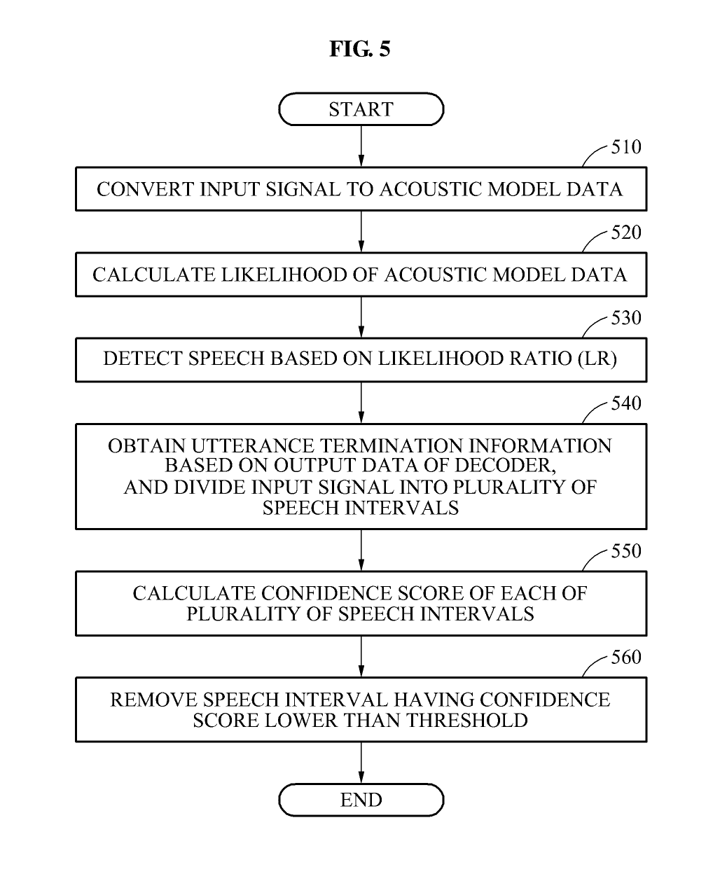

FIG. 5 is a flowchart illustrating an example of a speech recognition method according to an embodiment.

A speech recognition method 500 includes a speech detecting method and a speech segment selecting method, and provides a speech recognition method of which a speech recognition performance is enhanced. The speech recognition method 500 may include operation 510 of converting an input signal to acoustic model data, operation 520 of calculating a likelihood of the acoustic model data, operation 530 of detecting a speech based on an LR, operation 540 of obtaining utterance stop information on the acoustic model data and dividing the input signal into a number of speech segments, operation 550 of calculating a confidence score of each of the speech segments, and operation 560 of removing a speech segment having the confidence score lower than a threshold.

Operation 510 is an operation of converting an input signal to acoustic model data. Operation 510 may convert the input signal to the acoustic model data based on a sound modeling scheme used for speech recognition. For example, a sound modeling scheme may be at least one of a GMM and a DNN. In addition, operation 510 may further include an operation of calculating and storing a prior probability distribution for each class of each of a target speech and a noise speech according to the sound modeling scheme corresponding to the acoustic model data.

Operation 520 is an operation of calculating a likelihood of the acoustic model data. Operation 520 may include an operation of dividing the acoustic model data into a speech model group and a non-speech model group. In more detail, operation 520 may calculate a first maximum likelihood corresponding to the speech model group, a second maximum likelihood corresponding to the non-speech model group, and a third maximum likelihood corresponding to an entirety of the acoustic model data.

Operation 530 is an operation of detecting a speech based on an LR. In an example, a speech may be detected based on an LR of a first maximum likelihood and a second maximum likelihood. In another example, a speech may be detected based on an LR of a second maximum likelihood and a third likelihood. Operation 530 may include an operation of calculating an average LR based on the acoustic model data corresponding to a predetermined time interval. For example, operation 530 may detect a speech based on an average LR between a first maximum likelihood and a second maximum likelihood. Further, operation 530 may detect the speech based on an average LR between the second maximum likelihood and the third maximum likelihood. Operation 530 may include an operation of setting a threshold based on the acoustic model data. Operation 530 may detect the speech when the average LR is greater than the threshold.

Operation 540 is an operation of obtaining the utterance stop information based on the output data of the decoder and dividing the input signal into the speech segments. For example, the utterance stop information may be at least one of utterance pause information and sentence end information.

Operation 550 is an operation of calculating the confidence score of each of the speech segments. Operation 550 may calculate the confidence score of each of the speech segments based on information on a prior probability distribution of the acoustic model data. Operation 550 may approximate the prior probability distribution for each of a target speech class a noise speech class as a predetermined function, and calculate the confidence score using the predetermined function. For example, the predetermined function may be a beta function. Operation 550 may calculate a distance from the prior probability distribution of the acoustic model data based on the information on the prior probability distribution. For example, the information on the prior probability distribution may include at least one of a mean value and a variance value of the prior probability distribution.

A processing device may be implemented using one or more general-purpose or special-purpose computers, such as, for example, a processor, a controller and an arithmetic logic unit, a digital signal processor, a microcomputer, a field-programmable array, a programmable logic unit, a microprocessor, or any other device capable of running software or executing instructions. The processing device may run an operating system (OS), and may run one or more software applications that operate under the OS. The processing device may access, store, manipulate, process, and create data when running the software or executing the instructions. For simplicity, the singular term “processing device” may be used in the description, but one of ordinary skill in the art will appreciate that a processing device may include multiple processing elements and multiple types of processing elements. For example, a processing device may include one or more processors, or one or more processors and one or more controllers. In addition, different processing configurations are possible, such as parallel processors or multi-core processors.

Software or instructions for controlling a processing device to implement a software component may include a computer program, a piece of code, an instruction, or some combination thereof, for independently or collectively instructing or configuring the processing device to perform one or more desired operations. The software or instructions may include machine code that may be directly executed by the processing device, such as machine code produced by a compiler, and/or higher-level code that may be executed by the processing device using an interpreter. The software or instructions and any associated data, data files, and data structures may be embodied permanently or temporarily in any type of machine, component, physical or virtual equipment, computer storage medium or device, or a propagated signal wave capable of providing instructions or data to or being interpreted by the processing device. The software or instructions and any associated data, data files, and data structures also may be distributed over network-coupled computer systems so that the software or instructions and any associated data, data files, and data structures are stored and executed in a distributed fashion.

The above-described embodiments of the present invention may be recorded in non-transitory computer-readable media including program instructions to implement various operations embodied by a computer. The media may also include, alone or in combination with the program instructions, data files, data structures, and the like. Examples of non-transitory computer-readable media include magnetic media such as hard disks, floppy disks, and magnetic tapes; optical media such as CD ROMs and DVDs; magneto-optical media such as floptical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention, or vice versa.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

What is claimed is:

1. A speech recognition apparatus, comprising:
a converter configured to convert an input signal to acoustic model data;
a calculator configured to divide the acoustic model data into a speech model group and a non-speech model group and calculate a first maximum likelihood corresponding to the speech model group and a second maximum likelihood corresponding to the non-speech model group; and
a detector configured to detect a speech based on a likelihood ratio (LR) between the first maximum likelihood and the second maximum likelihood.

2. The apparatus of claim 1, wherein the converter is configured to convert the input signal to the acoustic model data based on a statistical model, and the statistical model comprises at least one of a Gaussian mixture model (GMM) and a deep neural network (DNN).

3. The apparatus of claim 1, wherein the calculator is configured to calculate an average LR between the first maximum likelihood and the second maximum likelihood based on the acoustic model data corresponding to a predetermined time interval, and the detector is configured to detect a speech based on the average LR.

4. The apparatus of claim 1, wherein the calculator is configured to calculate a third maximum likelihood corresponding to an entirety of the acoustic model data, and the detector is configured to detect a speech based on an LR between the second maximum likelihood and the third maximum likelihood.

5. The apparatus of claim 4, wherein the calculator is configured to calculate an average LR between the second maximum likelihood and the third maximum likelihood based on the acoustic model data corresponding to a predetermined time interval, and the detector is configured to detect the speech based on the average LR.

6. The apparatus of claim 1, wherein the detector is configured to detect a starting point at which the speech is detected from the input signal and set the input signal input subsequent to the starting point, as a decoding search target.

7. A speech recognition apparatus, comprising:
a determiner configured to obtain utterance stop information based on output data of a decoder and divide an input signal into a number of speech segments based on the utterance stop information;
a calculator configured to calculate a confidence score of each of the speech segments based on information on a prior probability distribution of acoustic model data; and
a detector configured to remove, among the speech segments, a speech segment having the confidence score lower than a threshold and perform speech recognition.

8. The apparatus of claim 7, wherein the utterance stop information comprises at least one of utterance pause information and sentence end information.

9. The apparatus of claim 7, wherein the calculator is configured to calculate and store the prior probability distribution for each class of each of a target speech and a noise speech according to a sound modeling scheme corresponding to the acoustic model data.

10. The apparatus of claim 9, wherein the calculator is configured to approximate the prior probability distribution for each class as a predetermined function, and calculate the confidence score using the predetermined function.

11. The apparatus of claim 9, wherein the calculator is configured to store the information on the prior probability distribution for each class, and calculate the confidence score based on the information on the prior probability distribution.

12. The apparatus of claim 11, wherein the calculator is configured to store at least one of a mean value or a variance value of the prior probability distribution as the information on the prior probability distribution.

13. The apparatus of claim 11, wherein the calculator is configured to calculate the confidence score and a distance from the prior probability distribution by comparing the information on the prior probability distribution to the acoustic model data of the speech segments.

14. A speech recognition method, comprising:
converting an input signal to acoustic model data;
dividing the acoustic model data into a speech model group and a non-speech model group and calculating a first maximum likelihood corresponding to the speech model group and a second maximum likelihood corresponding to the non-speech model group;
detecting a speech based on a likelihood ratio (LR) between the first maximum likelihood and the second maximum likelihood;
obtaining utterance stop information based on output data of a decoder when the detecting of the speech begins and dividing the input signal into a number of speech segments based on the utterance stop information;
calculating a confidence score of each of the speech segments based on information on a prior probability distribution of the acoustic model data; and
removing, among the plurality of speech intervals, a speech interval having the confidence score lower than a threshold.

15. The method of claim 14, wherein the detecting of the speech comprises calculating an average LR between the first maximum likelihood and the second maximum likelihood based on the acoustic model data corresponding to a predetermined time interval.

16. The method of claim 15, wherein the detecting of the speech comprises setting a threshold based on the acoustic model data and detecting the speech when the average LR is greater than the threshold.

17. The method of claim 14, wherein the converting comprises converting the input signal to the acoustic model data based on at least one of a Gaussian mixture model (GMM) and a deep neural network (DNN).

18. The method of claim 14, further comprising:
calculating and storing the prior probability distribution for each class of each of a target speech and a noise speech according to a sound modeling scheme corresponding to the acoustic model data.

19. The method of claim 18, wherein the calculating of the confidence score comprises approximating the prior probability distribution for each class as a predetermined function, and calculating the confidence score using the predetermined function.

20. The method of claim 18, wherein the calculating of the confidence score comprises calculating a distance from the prior probability distribution of the acoustic model data based on the information on the prior probability distribution, and the information on the prior probability distribution comprises at least one of a mean value and a variance value of the prior probability distribution.
